(19) United States
(12) Patent Application Publication
(10) Pub. No.: US 2024/0022874 A1
(43) Pub. Date: Jan. 18, 2024

(54) System and Method for Proximity-Based Information Organization During a Live Event

(71) Applicant: Timothy A. Chandler, Pittsburgh, PA (US)

(72) Inventor: Timothy A. Chandler, Pittsburgh, PA (US)

(21) Appl. No.: 18/219,351

(22) Filed: Jul. 7, 2023

Related U.S. Application Data
(60) Provisional application No. 63/390,147, filed on Jul. 18, 2022.

(51) Int. Cl. H04W 4/029; G06T 11/00; G01S 19/19; A63K 3/00; A63B 24/00

(52) U.S. Cl. CPC H04W 4/029; G06T 11/00; G01S 19/19; A63K 3/00; A63B 24/0021; A63B 2220/12; A63B 2225/50; A63B 2024/0025

(57) ABSTRACT

Computer systems and methods for improving the user experience at live events with regard to proximity-based information and data during a live event. In embodiments, a spectator may attend live sporting events (or other types of live events, such as rallies, parades, speaking events, and demonstrations). While attending these events, the spectator may have a smart phone or other mobile computing device having one or more application executing thereon. These applications may work in concert to provide an enhanced spectator experience for attendees via an augmented-reality (AR) application using local resources such as device cameras, GPS communication modules, and computer network connections. Using these resources, an attendee of various live events may access detailed data and information about the event such as leaderboards, changing rankings, locations of services, and location of participants.

### CROSS-REFERENCE TO RELATED APPLICATION

This application claims the benefit of priority from U.S. Provisional Patent Application No. 63/390,147, having a filing date of Jul. 18, 2022, the disclosure of which is incorporated herein, by reference, in its entirety.

### BACKGROUND

Live sporting events such as golf tournaments and car racing events as well as art and music festivals have large numbers of spectators that are observing activity that occurs across a large geographic area. For example, golfers in the tournament may be spread out across several different hole sin an 18-hole course. Likewise, race car drivers may be navigating around a racetrack that may be four of five miles in length. And art and music festivals feature multiple stages and artists across extensive city parks and downtown venues Thus, spectators may need to track multiple event participants in many locations simultaneously to gain a true appreciation of the competition or entertainment at hand.

Furthermore, several different point of interest locations may be of note to spectators that may choose to not remain in a single location. Thus, for roaming spectators, knowledge about location of and distances to food facilities, restroom facilities, emergency aid stations, and exits can be desired. Between keeping track of the competition and performances at hand as well as the additional aspects of live event facilities, a spectator desires to be able to quickly and easily navigate this information using a geo-located device, such as a portable computer of mobile phone.

### BRIEF DESCRIPTION OF THE DRAWINGS

Embodiments of the subject matter disclosed herein in accordance with the present disclosure will be described with reference to the drawings, in which:

FIG. 1 is a block diagram of a computer system across a computer network for realizing proximity-based organization of data during a live event according to an embodiment of the subject matter disclosed herein;

FIG. 2 is an overview diagram of a real-world layout for using the computer system across a computer network of FIG. 1 for realizing proximity-based organization of data during a live event according to an embodiment of the subject matter disclosed herein;

FIG. 3 is an exemplary screen shot of an application executing on a mobile device showing an augmented-reality view of proximity-based information during a live golf tournament according to an embodiment of the subject matter disclosed herein;

FIG. 4 is another exemplary screen shot of an application executing on a mobile device showing a horizon view having augmented-reality elements of proximity-based information during a live golf tournament according to an embodiment of the subject matter disclosed herein;

FIG. 5 is another exemplary screen shot of an application executing on a mobile device showing an aerial view having augmented-reality elements of proximity-based information during a live golf tournament according to an embodiment of the subject matter disclosed herein;

FIG. 6 is computing system for utilizing an application executing on a mobile device utilizing proximity-based information during a live event according to an embodiment of the subject matter disclosed herein;

FIG. 7 is a flow chart of a method for organizing and displaying information on a screen of a device executing and application for proximity-based organization of data during a live event according to an embodiment of the subject matter disclosed herein;

FIG. 8 is another flowchart of a method for organizing and displaying information on a screen of a device executing and application for proximity-based organization of data during a live event according to an embodiment of the subject matter disclosed herein; and

FIG. 9 is a diagram illustrating elements or components that may be present in a computer device or system configured to implement a method, process, function, or operation in accordance with an embodiment.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

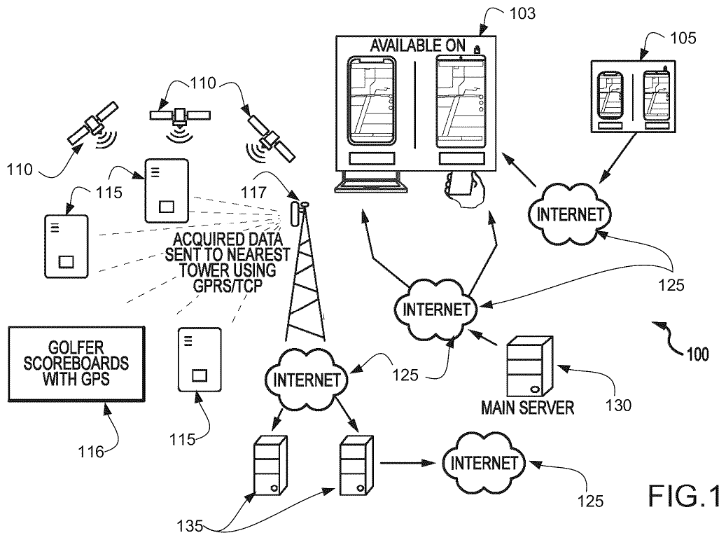

By way of overview, the systems and methods discussed herein may be directed to computer systems and methods for improving the user experience at live events with regard to proximity-based information and data during a live event. In embodiments, a spectator may attend live sporting events (or other types of live events, such as concerts, artistic performances, rallies, parades, speaking events, and demonstrations). While attending these events, the spectator may have a smart phone or other mobile computing device having one or more application executing thereon. These applications may work in concert to provide an enhanced spectator experience for attendees via an augmented-reality (AR) application using local resources such as device cameras, GPS communication modules, and computer network connections. Using these resources, an attendee of various live events may access detailed data and information about the event such as leaderboards, changing rankings, locations of services, and location of participants. For example, as a golfer in a gold tournament comes into proximity with the user, an alert may be triggered on a display identifying where the golfer is and the golfer's current tournament score/ranking. Similarly, a specific race car may be tracked during a race when a field of competitors is outside of view of the user. Still further, different artists performing on different stages may be tracked and displayed according to actual start and stop times at a music festival. These and other aspects of this stem are discussed below and better understood in eth context of the FIGS. 1-8.

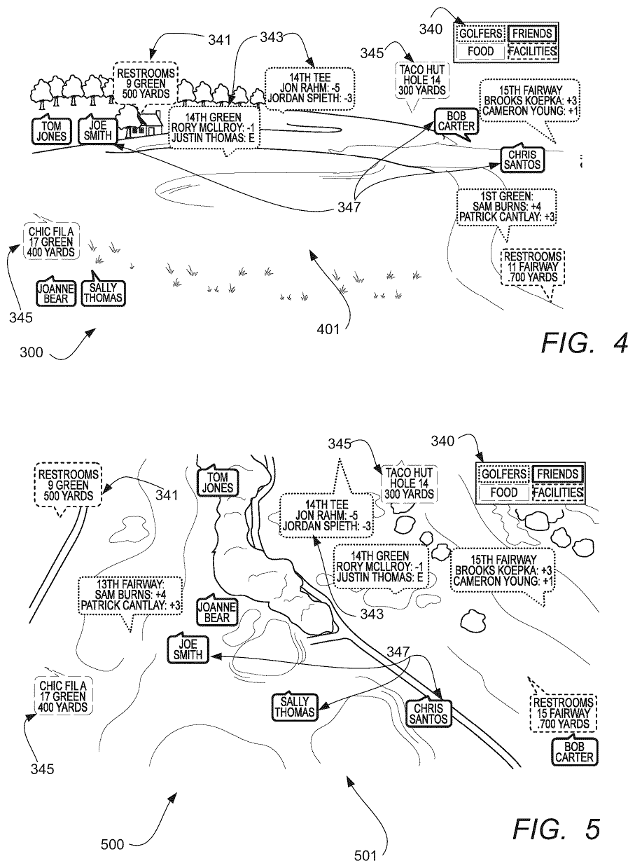

FIG. 1 is a block diagram of a computer system 100 having several different computing devices cooperating and communications through a large-scale computer network 125 such as the Internet. The various computing devices realized in this system cooperate and execute functionality for a proximity-based organization of data during a live event according to an embodiment of the subject matter disclosed herein. As alluded to above, live events pose interesting and unique problems for a user in navigating specific information that may or may not be available while attending the event. For example, a user may wish to track and follow several different interactive entities, such as different golfers on a golf course at a golf tournament along with real-time information about how the golfer is doing in the tournament. Thus, the system realized in FIG. 1 can not only provide information and data about stationary places of interest (e.g., what is happening on the 5^{th} green) but also real-time updatable data about moving objects (e.g., where is my favorite golfer right now and what is that golfer's score in relation to other tournament participants). FIG. 1 will be described in terms of specific computing devices that are within the overall system 100 and the descriptions of FIG. 5 below will delve further into details about specific types of data in which the systems may utilize.

In this embodiment, a user device 103 such as a smart phone or mobile computer may be executing an application for collecting, assimilating, organizing and displaying different kinds of data and information on a display of the mobile computing device. In other embodiments, this device may be a more stationary computer device such as a desktop computer or computing kiosk designed to remain in one place during the duration of an event. Each of the user computers 103 may be coupled to the Internet 125 so as to communicate with several other computing devices. Other computing devices may also include other users' mobile computing devices 105 as well. Together, all of these computing systems may collect and disseminate information to any other computing device in the system about specific details and occurrences during the live event.

The information involved with collection and dissemination may include GPS data that may derived from the Global Positioning System (GPS) so as to geolocate any connected device to the overall system 100 and regularly update respective locations. The GPS system includes a number of satellite systems 110 wherein several different additional computing devices 115 communicate with each other and the satellites 110 to determine specific global locations for specific connected devices. For example, a golfer in a golf tournament may have an associated placard or scorecard 116 carried by a caddy with the golfer's name. The placard may be GPS-equipped mobile computing device that regularly communicated with the Internet 125 and the GPS system to as to update the overall system as to geolocation. As another example, a race car may have a GPS-equipped mobile computing device placed in board the car during a race such that the system 100 may also be updated with specific geo-location of the race car in real time on served applications. In still further, examples, convention floor booths may have GPS-equipped mobile computing devices that communicate with the system 100 during a convention. In each of these examples (as well as other embodiments), the GPS-equipped mobile computing devices 116 may be turned off before the event begins and after the event ends so as to maintain the privacy of the GPS-equipped mobile computing device 116.

As various data points and information is collected and disseminated, the GPS data may be routed through one or more communications towers 117 that are communicatively coupled to a pair of redundant control center server computers 135. The redundant control center computers 135 may be executing the overall application for proximity-based information organization during a live event. Thus, as user devices 103 and 105 connect to the system, communication with the redundant control center server computers 135 may be established. In embodiments, each user device 103 or 105 may have an already installed application for interfacing the overall live event management system and each user device may have a pre-established user relationship (e.g., username and password credentials, and sometimes, payment credentials) with the server application from the redundant control center server computers 135.

In embodiments, the system 100 includes a main server computer 130 coupled to the Internet 125 that may be used to store legacy data and back-end functionality data for the redundant control center server computers 135. The main server computer 130 (sometimes called the back office server) may be the primary data source for all live event information. For example, for golf events, the main server computer 130 may store golfers current scores, tournament standings, and sponsor details. As another example, for race events the main server computer 130 may store drivers' current position, speed, and sponsor details. As yet another example, for festivals the main server computer 130 may store a schedule for each performer, locations of the performance, and data specific to the festival location and performers. For the remainder of this disclosure, only examples form a live golfing event may be used to describe functionality and capabilities of the overall system and method, though a skilled artisan understands that these example application and functions apply equally to any of the live events described above and other live events not described herein.

In further embodiments, additional system-enabled computing devices (not shown in FIG. 1 but connected to the Internet 125) may be involved such as contemporary devices of other spectators as well as server computers that may track data and information from additional third-party systems (e.g., PGA servers, NASCAR servers, and the like). As is discussed in greater detail below, any number of computing devices may be involved in the overall computing system of FIG. 1 and coupled to the computer network (e.g., the Internet 125).

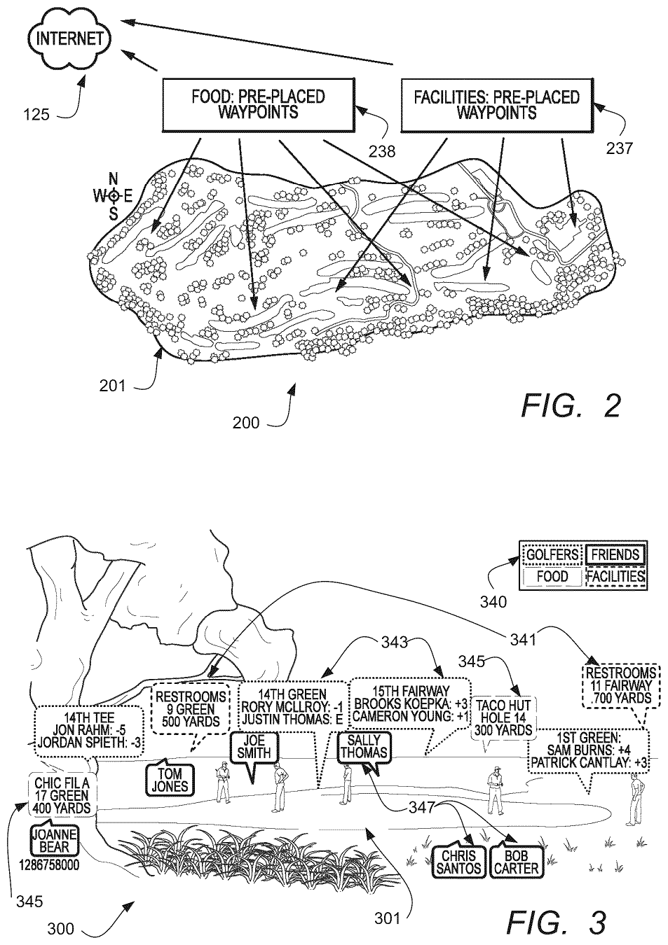

FIG. 2 is an overview diagram 200 of a real-world layout 201 for using the computer system across a computer network of FIG. 1 for realizing proximity-based organization of data during a live event according to an embodiment of the subject matter disclosed herein. This real-world layout 201 may be stored in a server computer associated with a venue, such as the golf course hosting the tournament or the racetrack hosting the car race. This information may be used to serve connected mobile computing devices (103 and 105 of FIG. 1) with maps through an Internet-connected application executing thereon. The information served may be a map of the overall golf course (in this embodiment) that also includes additional data and information such as locations 238 of food-based services or locations 237 of restroom facilities in the context of the overlayed course map 201. In embodiments, these locations 237 and 238 may be static and part of a fixed map. In other embodiments, these locations 237 and 238 may also be dynamic and trackable using GPS-enabled mobile computing devices (e.g., mobile food truck or portable restroom). The view shown in FIG. 2 may be intended to be relatively static within the context of the application executing on the user devices. In other enabled functionality, the user may enable a real-time view with continuously updated information (e.g., augmented-reality elements) as eth live event unfolds. These additional dynamic views are discussed next with respect to FIGS. 3-5.

FIG. 3 is an exemplary screen shot 300 of an application executing on a mobile device showing a camera view having augmented-reality elements of proximity-based information during a live golf tournament according to an embodiment of the subject matter disclosed herein. In the screen shot 300, an embodiment shows that some dynamic information (e.g., augmented-reality elements) that can be displayed may be overlayed on the image 301 captured by a device camera (not shown here) and displayed on the screen (e.g., the image 301) of the device. The augmented-reality elements displayed in real-time may be static (e.g., the location does not move independent of the user) or dynamic (e.g., the location does move independent of the user). Thus, as a user moves about the locations of both static and dynamic augmented-reality elements will also move about the displayed screen just as the underlying image changes to capture new views when the user moves.

For example, in FIG. 3, one embodiment may track the dynamic augmented-reality elements of locations 343 of scorecards or placards (e.g., GPS-enabled mobile computing devices 116 of FIG. 1) associated with tournament golfers who happen to be in the field of view of the user device within a specified proximity of the user. In one embodiment, this proximity is 500 yards, but this proximity may be set differently by the user or by the event management system. Additionally, the tag shown in the screen shot 300 indicating the location 343 of the golfer's placard may also be populated with additional information such as current hole, current score, and leaderboard position. Further yet, as a golfer's score (in relation to par) changes, the ID tag may temporarily flash or change color to indicate a live scoring update in the user's view. Thus, the augmented-reality elements not only include GPS-enabled data derived from GPS-enabled mobile device at or near the golfer, but it may also draw other live event information such as score, and golf hole form a third-party system executed by event management.

In a similar manner, other user's device (105 of FIG. 1) may also be displayed by location as an augmented-reality element 347. In the example, of FIG. 3, Chris Santos, Sally Thomas, and Bob Carter 347 may be displayed as augmented-reality elements on the user's view while the live event is currently still running. In a similar manner, to protect the privacy of the friend's device, the live event may end and this trackability is no longer enabled. Additional augmented-reality elements may be displayed and may be anchored information such as which golf hole green may be shown or where restroom facilities 341 and food services 345 are located.

In embodiments, the user's display screen may also show a local control panel 340 with filters for toggling one or more types of augmented-reality elements on and off. For example, one could turn off the facilities 341 locations until one desires to locate them. In other embodiments, a nested menu may be available for a user to turn off and on augmented-reality elements for specific locations, golfers, or friends. These filters may be color-coded for different types of data for display. As the camera is rotated additional items that are within the camera's field of view will become visible to the user with locations, distances, names, scores, and the like. The four primary filters can be selected individually to minimize information being shown on the screen. If preferred, additional filters can be added for other features such as hospitality or corporate sponsored tents and pro/souvenir shops. Micro filters for food venues and favorite golfers may also be added to focus on interests and reduce screen clutter.

Golfer tracking (e.g., mobile computing device on golfer placard, or the like) may primarily utilize the Optimus Real Time GPS Tracing Device or GPS Tracking Device with worldwide 5G/4G/LTE subscription per set of golfers per day. Each tracker may be assigned to the golfers playing together for reporting in the application and location services. Every day, each tracker may be assigned to the golfers together. Further, golfers may be tracked at three locations per hole—tee box, fairway, and the green. 30-60 second updates may be sufficient for accurate location services. Further, battery life should be sufficient for 1 day with updates every 30 seconds.

In other embodiments, friends tracking would be available as an option for anyone who downloads the application and shares their location with other friends via the application. The system may also integrate with Facebook and Instagram location sharing as well to generate further use and connections. Food and facilities locations may be located via waypoints prior to the event and could be added during the events if there are ad hoc changes. Additional filters that could be added may be hospitality tents, storm shelters, pro shops, and the like.

In other embodiments, real-time statistics may be assimilated and tracked that include mobile ticket requirements by event; rate of technology acceptance at events, number of global tour events, number of events by organization (PGA, and the like.), number of attendees per day of each event, and number of downloads of the application.

FIG. 4 is another exemplary screen shot 400 of an application executing on a mobile device showing a horizon view having augmented-reality elements of proximity-based information during a live golf tournament according to an embodiment of the subject matter disclosed herein. In this screen shot 400, an embodiment shows that the information that can be displayed may be overlayed on a computer-generated image 401 based upon the location of the device and displayed on the screen of the device as if one were floating above a current position by roughly 100 feet or so and looking slightly down toward the horizon. For example, in FIG. 4, the information displayed may include (similar to FIG. 3) some dynamic information (e.g., augmented-reality elements) that can be displayed may be overlayed on the image 401 generated by the a GPS-enabled service (not shown here) executing on the redundant control center computers 135 (FIG. 1) and displayed on the screen (e.g., the image 401) of the device. The augmented-reality elements displayed in real-time may be static (e.g., the location does not move independent of the user) or dynamic (e.g., the location does move independent of the user). Thus, as a user moves about the locations of both static and dynamic augmented-reality elements will also move about the displayed screen just as the underlying image changes to capture new views when the user moves.

For example, in FIG. 4, one embodiment may track the dynamic augmented-reality elements of locations 343 of scorecards or placards (e.g., GPS-enabled mobile computing devices 116 of FIG. 1) associated with tournament golfers who happen to be in the field of view of the user device within a specified proximity of the user. In one embodiment, this proximity is 500 yards, but this proximity may be set differently by the user or by the event management system. Additionally, the tag shown in the screen shot 400 indicating the location 343 of the golfer's placard may also be populated with additional information such as current hole, current score, and leaderboard position. Further yet, as a golfer's score (in relation to par) changes, the ID tag may temporarily flash or change color to indicate a live scoring update in the user's view. Thus, the augmented-reality elements not only include GPS-enabled data derived from GPS-enabled mobile device at or near the golfer, but it may also draw other live event information such as score, and golf hole form a third-party system executed by event management.

In a similar manner, other user's device (105 of FIG. 1) may also be displayed by location as an augmented-reality element 347. In the example, of FIG. 4, Chris Santos, Sally Thomas, and Bob Carter 347 may be displayed as augmented-reality elements on the user's view while the live event is currently still running. In a similar manner, to protect the privacy of the friend's device, the live event may end and this trackability is no longer enabled. Additional augmented-reality elements may be displayed and may be anchored information such as which golf hole green may be shown or where restroom facilities 341 and food services 345 are located.

In embodiments, the user's display screen may also show a local control panel 340 for toggling one or more types of augmented-reality elements on and off. For example, one could turn off the facilities 341 locations until one desires to locate them.

In other embodiments, a nested menu may be available for a user to turn off and on augmented-reality elements for specific locations, golfers, or friends.

FIG. 5 is another exemplary screen shot 500 of an application executing on a mobile device showing an aerial view having augmented-reality elements of proximity-based information during a live golf tournament according to an embodiment of the subject matter disclosed herein. In this screen shot 500, an embodiment shows that the information that can be displayed may be overlayed on a computer-generated image 501 based upon the location of the device and displayed on the screen of the device as if one were floating above a current position by roughly 400 feet or so and looking straight down. For example, in FIG. 5, the information displayed may include (similar to FIG. 3) some dynamic information (e.g., augmented-reality elements) that can be displayed may be overlayed on the image 501 generated by the a GPS-enabled service (not shown here) executing on the redundant control center computers 135 (FIG. 1) and displayed on the screen (e.g., the image 501) of the device. The augmented-reality elements displayed in real-time may be static (e.g., the location does not move independent of the user) or dynamic (e.g., the location does move independent of the user). Thus, as a user moves about the locations of both static and dynamic augmented-reality elements will also move about the displayed screen just as the underlying image changes to capture new views when the user moves.

For example, in FIG. 5, one embodiment may track the dynamic augmented-reality elements of locations 343 of scorecards or placards (e.g., GPS-enabled mobile computing devices 116 of FIG. 1) associated with tournament golfers who happen to be in the field of view of the user device within a specified proximity of the user. In one embodiment, this proximity is 500 yards, but this proximity may be set differently by the user or by the event management system. Additionally, the tag shown in the screen shot 400 indicating the location 343 of the golfer's placard may also be populated with additional information such as current hole, current score, and leaderboard position. Further yet, as a golfer's score (in relation to par) changes, the ID tag may temporarily flash or change color to indicate a live scoring update in the user's view. Thus, the augmented-reality elements not only include GPS-enabled data derived from GPS-enabled mobile device at or near the golfer, but it may also draw other live event information such as score, and golf hole form a third-party system executed by event management.

In a similar manner, other user's device (105 of FIG. 1) may also be displayed by location as an augmented-reality element 347. In the example, of FIG. 5, Chris Santos, Sally Thomas, and Bob Carter 347 may be displayed as augmented-reality elements on the user's view while the live event is currently still running. In a similar manner, to protect the privacy of the friend's device, the live event may end and this trackability is no longer enabled. Additional augmented-reality elements may be displayed and may be anchored information such as which golf hole green may be shown or where restroom facilities 341 and food services 345 are located.

In embodiments, the user's display screen may also show a local control panel 340 for toggling one or more types of augmented-reality elements on and off. For example, one could turn off the facilities 341 locations until one desires to locate them.

In other embodiments, a nested menu may be available for a user to turn off and on augmented-reality elements for specific locations, golfers, or friends.

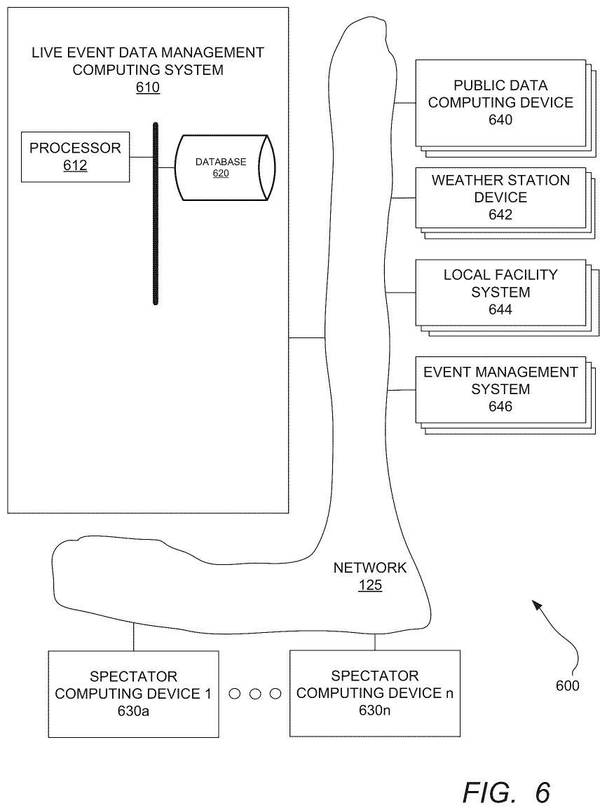

FIG. 6 is computing system for utilizing an application executing on a mobile device utilizing proximity-based information during a live event according to an embodiment of the subject matter disclosed herein. The system 600 includes a live-event data management server computer 610 having one or more processors 612 and one or more local databases 620. The live-event data management server computer 610 of FIG. 6 may be the same redundant control center computer set 135 of FIG. 1. The live-event data management server computer 610 is communicatively coupled to a computer network 125 (e.g., the Internet) which then may be communicatively coupled to several other computers. These additional computers may be other user computing devices 630a-630n (e.g., user devices 103 and 105 of FIG. 1). Additionally, other information collecting computers may be coupled to the computer network 625 such as public data computer systems 640, public weather data systems 642, local data systems 644, and event management systems 646.

User computing devices 630a-630n may be associated with target audience members that typically include PGA tour attendees, LPGA tour attendees, Pro Am tour attendees, NASCAR event attendees, Formula One attendees, Indy Circuit attendees, and public event attendees. Each user device 630a-630n may be executing an event-information organization application having a pre-established relationship with the live-event data management server computer 610 that is executing a platform-based event information organization enterprise program. The cooperation of the live-event data management server computer 610 and each user device 630a-630n, as a pre-established credentialed relationship allows for certain private or proprietary information to be disseminated to each user device 630a-630n. Together with the third-party service computing devices 640, 642, 644, and 646, each user device 630a-630n may impart functionality to a user that greatly enhances enjoyment of a live event.

In a first example function, and as discussed previously each user device Each user device 630a-630n may enable use of respective camera functionality to create augmented-reality experience for users viewing a screen such that information is presented in real time on the screen in a relative location to reality. In a second example function, the use of GPS services and QR codes on score placards to track and locate golfers throughout the course may be enabled during a live golf event. Further, the use of information provided may also include users' current location, location of golfers, their current score, and the like. throughout entire course and throughout the entire duration of the live golf event. Additional functionality may include course maps and best route selection about the golf course during the live golf event as well as season statistics about the PGA tour and individual statistics of players.

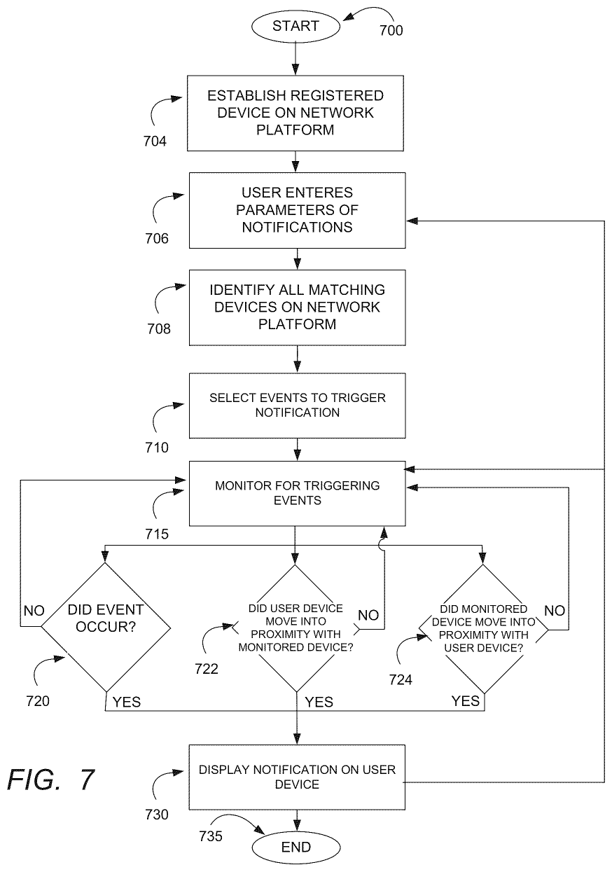

FIG. 7 is a flow chart of a method for organizing and displaying information on a screen of a device executing and application for proximity-based organization of data during a live event according to an embodiment of the subject matter disclosed herein. The method may start at step 700 and then move to step 704 to establish one or more registered devices with the live-event information management system. Registration may have occurred and some prior point in time such that this step is merely a log in once the event has started. When registered/logged in, the user may select specific parameters of notifications and augmented-reality elements at step 706. That is, one may select favorite golfers, specific food locations, friends, or facilities to display when in proximity to the user. Once the parameters and augmented-reality elements have been set by the user, the platform determines all matching mobile devices that meet the parameters for then displaying on the augmented reality screen of the user device and step 708. Next, a user may also select specific triggering events to monitor at step 710 (e.g., tracked golfer comes into proximity, friend comes into proximity, and the like)

Then, the method will enter a monitoring loop for any triggering event at step 715. Thus, in this embodiment, three simultaneous trigger monitoring loops are created with an update check every 30 seconds or so. The first loop monitors for the occurrence of an event at query step 720. The occurrence of an event may be that a specific golfer has scored well on a hole, a hospitality tent has opened, or that ordered food is ready for pickup as but three examples. The second loop monitors for a remote mobile device to be moved into proximity of the user device at query step 722. This may be that a specific golfer has come with 500 yards of the user, a friend has come with 500 yards of the user, or that a food cart has entered a proximate area as but three examples. The third loop monitors for the user device to move into proximity with a stationary location at query step 724. This may be that the user has come with 500 yards of facilities, a clubhouse, or one's parked car as but three examples.

In each of these looped monitoring cases above, when a triggering event is detected, the user device may change its augmented reality display to indicate this detection at step 730. This could be simply displaying another bubble on the screen or may trigger a blinking or color change to impart a more urgent notification to the user. The overall method may loop back around to continue monitors for triggering events or changing parameters or the method may end at step 735.

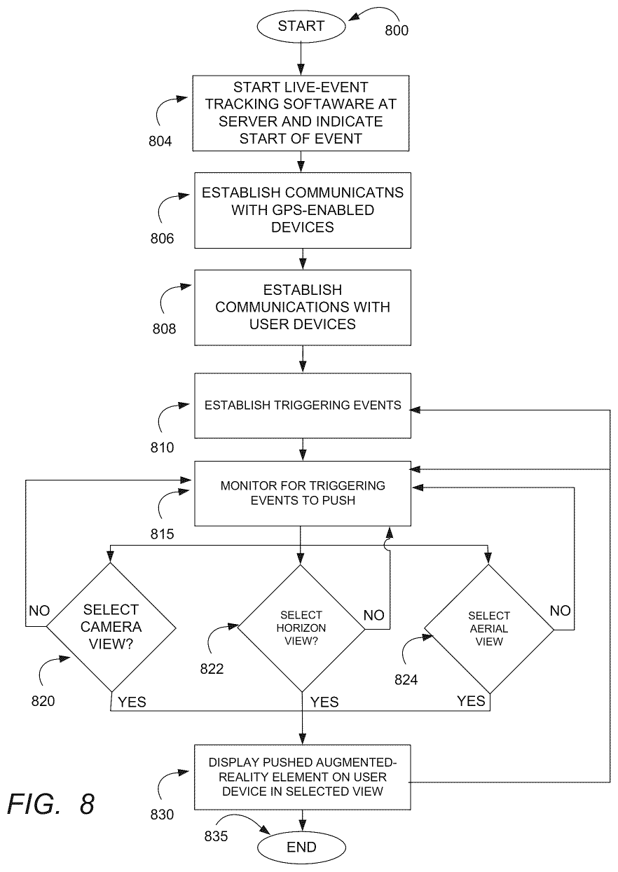

FIG. 8 is another flow chart of a method for organizing and displaying information on a screen of a device executing and application for proximity-based organization of data during a live event according to an embodiment of the subject matter disclosed herein. The method may start at step 800 and then move to step 804 to instantiate the live-event information management system platform and then indicate that that the live event has started thereby enabling the GPS tracking functionality of all registered devices. Registration may have occurred and some prior point in time such that this step is merely a wake-up signal and an initial collection of GPS data at step 806. Similarly, when registered/logged in, one or more user devices may also establish communications with the live-event information management system platform at step 808. As before, registration may have occurred and some prior point in time such that this step is merely a wake-up signal and an initial collection of GPS data and other parameters for setting up retrieval of augmented-reality elements data. Also as before, each user device may establish triggering events (e.g., augmented-reality element parameters) at step 810. That is, one may select favorite golfers, specific food locations, friends, or facilities to display when in proximity to the user.

Once the parameters and augmented-reality elements have been set by the one or more user devices, the platform determines all matching augmented-reality elements that meet the parameters for then displaying on the augmented reality screen of each respective user device. Then, the method will enter a monitoring loop for any triggering event at step 815. Thus, in this embodiment, three simultaneous trigger monitoring loops are created with an update check every 30 seconds or so. The first loop monitors for the triggering of augmented-reality elements for user devices in a camera view mode at query step 820. The second loop monitors for the triggering of augmented-reality elements for user devices in a horizon view mode at query step 822. The third loop monitors for the triggering of augmented-reality elements for user devices in an aerial view mode at query step 824.

In each of these looped monitoring cases above, when a triggering event is detected, the user device may receive a pushed notification to change its augmented reality display to indicate this detection at step 830. This could be simply displaying another bubble on the screen or may trigger a blinking or color change to impart a more urgent notification to the user. The overall method may loop back around to continue monitoring for triggering events or changing parameters or the method may end at step 835. At the end step 835, this may involve turning off functionality at the live-event information management system platform by indicating to the server computer that the live event has ended thereby terminating communication with and stopping the tracking of GPS location of the plurality of GPS-enable computing devices associated with the live event.

In an embodiment, displaying the augmented-reality element further comprises displaying the augmented-reality element associated with one of the plurality of GPS-enabled computing devices if the respective GPS location of the respective GPS-enabled device is determined to be within 500 yards of the user computing device. IN another embodiment, indicating to the server computer that the live event has commenced further comprises indicating that a golf tournament has commenced, a race event has commenced, or a convention has commenced. In still further embodiments, each user device may also have waypoint functionality in receiving input from the user to determine waypoints on the user's display and then generating walking directions in response to establishing the waypoints.

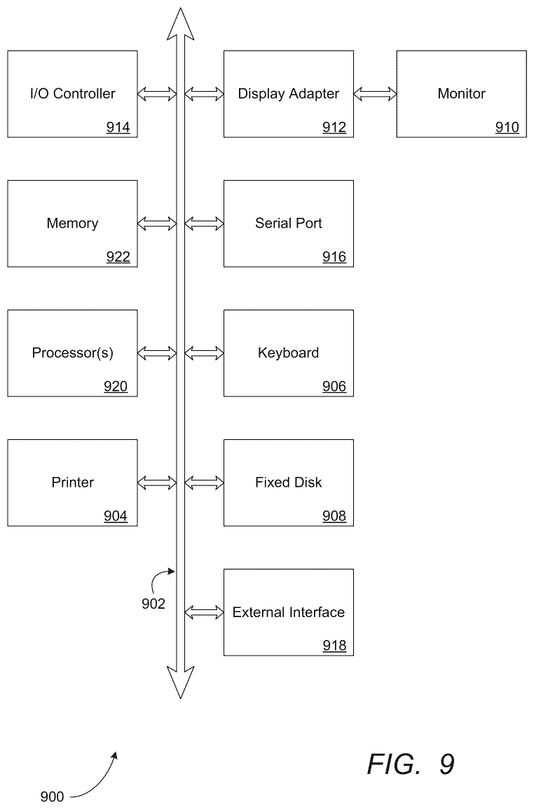

FIG. 9 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. As an example, FIG. 9 is a diagram illustrating elements or components that may be present in a computer device or system 900 configured to implement a method, process, function, or operation in accordance with an embodiment. The subsystems shown in FIG. 9 are interconnected via a system bus 902. Additional subsystems may include a printer 904, a keyboard 906, a fixed disk 908, and a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 9 including a wide area network such as the Internet, a mouse input device, and/or a scanner. The interconnection via the system bus 902 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Assembly language Java, JavaScript, C, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A computing system in a cloud computing environment for providing live updates at an event location, comprising:
a first mobile computing device having a processor configured to execute tangible computer-readable instructions for a live-event information tracking application;
a plurality of GPS-enabled computing devices trackable by a live-event information management system and enabled to be GPS tracked during a live event but not trackable before the event begins or after the events ends;
a server computer for registering the first mobile computing device at an event and configured to track via a GPS system each of the second plurality of mobile computing devices;
wherein the first mobile computing device is configured to execute tangible computer-readable instructions to display augmented reality elements on an overlay of an image on a screen if one or more trackable GPS-enabled mobile computing devices are within a proximity to the first mobile computing device during the live event.

2. The computing system of claim 1, wherein at least one of the GPS-enabled computing devices comprises a mobile GPS-enabled computing device.

3. The computing system of claim 1, wherein at least one of the GPS-enabled computing devices comprises a stationary GPS-enabled computing device.

4. The computing system of claim 1, wherein the live event comprises a golf tournament and at least one of the plurality of GPS-enabled devices comprises a golfer placard at the golf tournament associated with at least one golf tournament participant.

5. The computing system of claim 1, wherein the live event comprises a racing event and at least one of the plurality of GPS-enabled devices comprises a device mounted to a participant in the racing event.

6. The computing system of claim 1, wherein the live event comprises a convention and at least one of the plurality of GPS-enabled devices comprises a device mounted to a booth participant at the convention.

7. The computing system of claim 1, wherein at least one of the augmented reality elements comprises a second mobile computing device associated with a known friend of a user of the first mobile computing device.

8. The computing system of claim 1, wherein at least one of the augmented reality elements comprises a second mobile computing device associated with a favorite participant in the live event.

9. The computing system of claim 1, wherein at least one of the augmented reality elements comprises a physical stationary location having a GPS-enabled computing device affixed thereto.

10. The computing system of claim 1, wherein the first mobile computing device is configured to execute tangible computer-readable instructions to display a configurable menus of selectable augmented reality elements on an overlay of the image on the screen during the live event.

11. A computing method of providing live updates about a live event during the live event to attendees of the live event, the method comprising:
executing a live-event information tracking system at a server computer communicatively coupled to a computer network:
indicating to the server computer that the live event has commenced;
establish communication and determine GPS location of a plurality of GPS-enable computing devices associated with the live event via the computer network;
tracking the plurality of GPS-enabled devices computing devices and pushing updates to one or more user computing devices having a pre-established credentialed relationship with the live-event information tracking system;
displaying an augmented-reality element associated with one of the plurality of GPS-enabled computing devices overlayed on an image displayed on the user computer device if the respective GPS location of the respective GPS-enabled device is determined to be in proximity to the user computing device;
indicating to the server computer that the live event has ended;
terminate communication and stop tracking GPS location of the plurality of GPS-enable computing devices associated with the live event.

12. The method of claim 11, wherein displaying the augmented-reality element further comprises displaying the augmented-reality element associated with one of the plurality of GPS-enabled computing devices if the respective GPS location of the respective GPS-enabled device is determined to be within 500 yards of the user computing device.

13. The method of claim 11, wherein indicating to the server computer that the live event has commenced further comprises indicating that a golf tournament has commenced.

14. The method of claim 11, wherein indicating to the server computer that the live event has commenced further comprises indicating that a racing event has commenced.

15. The method of claim 11, wherein indicating to the server computer that the live event has commenced further comprises indicating that a convention has commenced.

16. The method of claim 11, further comprising:
receiving input from the user to determine waypoints on a display; and
generating walking directions in response to establishing the waypoints.

17. The method of claim 11, further comprising:
receiving input at a menu on the display of the user computer device from the user to determine type of augmented-reality elements to receive push updates; and
display only the selected type of augmented-reality element.

18. The method of claim 11, wherein displaying the augmented-reality element further comprises displaying the augmented-reality element on an image representing an arial view from the GPS location of the user computing device.

19. The method of claim 11, wherein displaying the augmented-reality element further comprises displaying the augmented-reality element on an image representing a horizon view from the GPS location of the user computing device.

20. The method of claim 11, wherein displaying the augmented-reality element further comprises displaying the augmented-reality element on an image captured by a camera on the GPS location of the user computing device.
